(19) United States
(12) Patent Application Publication
(10) Pub. No.: US 2013/0035998 A1
(43) Pub. Date: Feb. 7, 2013

(54) DEVICE, METHOD AND PROGRAM FOR MANAGING FEEDBACK FROM VIEWERS REGARDING DISTRIBUTED CONTENT

(71) Applicant: Soo-Hyun Chae, Tokyo (JP)

(72) Inventor: Soo-Hyun Chae, Tokyo (JP)

(73) Assignee: BRIGHTWISE ASSOCIATES, INC., Tokyo (JP)

(21) Appl. No.: 13/576,967

(22) PCT Filed: Feb. 3, 2011
(86) PCT No.: PCT/JP2011/052293

§ 371 Date: Oct. 23, 2012

(30) Foreign Application Priority Data
Feb. 3, 2010 (JP) 2010-022273

(51) Int. Cl. G06Q 30/02

(52) U.S. Cl. 705/14.19; 705/14.4

(57) ABSTRACT

An apparatus according to an embodiment of the present invention is connected to and capable of communication with a plurality of information processing terminals through a network, the apparatus including: distribution means for distributing digital content to at least one of the plurality of information processing terminals; providing means for providing, to the at least one of the plurality of information processing terminals, one or more content constituent elements associated with the digital content and an input form that allows inputting feedback information using the content constituent elements in the at least one of the plurality of information processing terminals; reception means for receiving, from the at least one of the plurality of information processing terminals, feedback information input using the input form; and feedback information storage means for accumulating the feedback information to allow browsing from the plurality of information processing terminals through the network if the feedback information includes at least one of the content constituent elements.

### TECHNICAL FIELD

The present invention relates to an apparatus that manages feedback from a viewer to distribution content, and more particularly, to an apparatus that provides, to an information processing terminal of a viewer, content constituent elements for creating feedback.

### BACKGROUND ART

A digital content distribution service for distributing digital content, such as moving images, from a content server apparatus to an information processing terminal is widely used. A server apparatus that provides the content distribution service may have a function of receiving feedback, such as comments related to the distribution content, to encourage interactions between viewers. Comments related to specific content are stored in the server apparatus in association with the content, and the comments are transmitted to the terminal of the viewer along with the content. In this way, the viewer can recognize the comments by other viewers related to the content, and interactions between the viewers are encouraged.

However, contrary to the objective of the interactions, comments not related to the content or morally inappropriate comments may be posted. To prevent the inappropriate comments, a technique for monitoring the comments according to a predetermined algorithm is known. For example, in Japanese Patent Laid-Open No. 2002-342146 (Patent Literature 1), inappropriate words are stored in advance as keywords, and the words equivalent to the keywords are deleted from the posted comments to prevent the inappropriate comments.

Meanwhile, a policy of not permitting free posting of comments may be adopted. In this case, for example, a service provider scrutinizes the comments. The comments are provided to the viewer, and the viewer can browse only the comments determined to be proper.

### CITATION LIST

### Patent Literature

Patent Literature 1: Japanese Patent Laid-Open No. 2002-342146

### SUMMARY OF INVENTION

### Technical Problem

The present invention is intended to provide various improvements of the conventional technique. The inventor of the present invention has specified the following problems in the conventional technique. Great effort is necessary to create the list of inappropriate words without omission and to maintain a proper state of the list after the creation, and this may be difficult to realize. If free commenting is not permitted, the disclosure of inappropriate comments can be surely prevented. On the other hand, the degree of freedom of feedback to the viewed content is reduced, and the viewer may be reluctant to provide feedback. Therefore, various embodiments of the present invention provide an apparatus that can appropriately manage feedback from a viewer to distributed content.

### Solution to Problem

The inventor of the present invention has discovered that content constituent elements associated with distribution content can be provided to an information processing terminal of a viewer to allow browsing only comments of feedback information including the content constituent elements to thereby suppress inappropriate comments by more simple setting, without substantially inhibiting the degree of freedom of commenting by the viewer.

An apparatus according to an embodiment of the present invention is connected to and capable of communication with a plurality of information processing terminals through a network. The apparatus includes: storage means for storing a plurality of digital contents, each associated with a content identifier for identifying the digital content and one or more content constituent elements; distribution means for distributing at least one of the plurality of digital contents to at least one of the plurality of information processing terminals; providing means for providing, to the at least one of the plurality of information processing terminals, the content constituent elements associated with the digital content distributed from the distribution means and an input form for inputting information to the at least one of the plurality of information processing terminals; reception means for receiving, from the at least one of the plurality of information processing terminals, feedback information including information input using the input form, along with the content identifier associated with the digital content distributed from the distribution means; determination means for determining whether the feedback information includes at least one of the content constituent elements associated with the digital content distributed from the distribution means based at least partially on the content identifier received by the reception means; and feedback information storage means for accumulating at least part of the feedback information to allow browsing from the plurality of information processing terminals through the network if the reception means determines that the content constituent element is included.

In this way, an embodiment of the present invention provides an apparatus that can appropriately manage the feedback from the viewer for the distributed content. For example, in an embodiment of the present invention, the feedback information including the content constituent elements is accumulated and can be browsed from the information processing terminal, while the feedback information not including the content constituent elements cannot be browsed from the information processing terminal. This can more simply manage the feedback information disclosed to the information processing terminal, through the setting of the content constituent elements. The viewer can easily post a comment or the like by creating the feedback information based on the provided content constituent elements. In this way, inappropriate comments can be effectively suppressed without inhibiting the convenience of the viewer.

The present invention is realized by various embodiments disclosed through the specification and the drawings.

### BRIEF DESCRIPTION OF DRAWINGS

FIG. 1 is a network configuration diagram schematically showing an embodiment of the present invention.

FIG. 2 is a block diagram schematically showing architecture of a server apparatus 104 according to an embodiment of the present invention.

FIG. 3 is a block diagram schematically showing functions of the server apparatus 104 according to an embodiment of the present invention.

FIG. 4 is a diagram schematically showing a content management table 400.

FIG. 5 is a diagram schematically showing a feedback information management table 500,

FIG. 6 is a flow diagram showing a processing procedure according to an embodiment of the present invention.

### DESCRIPTION OF EMBODIMENTS

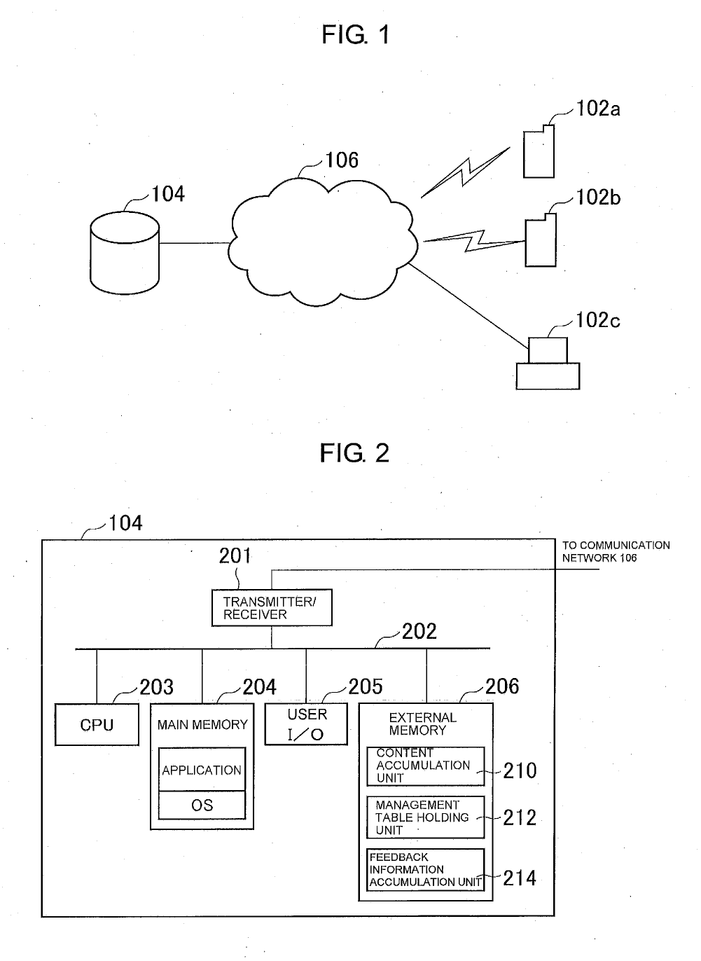

Embodiments of the present invention will now be described with reference to the drawings as necessary. FIG. 1 is a network configuration diagram schematically showing an embodiment of the present invention. As shown in FIG. 1, a server apparatus 104 according to an embodiment of the present disclosure is connected to and capable of communication with a plurality of information processing terminals 102a, 102b, and 102c (hereinafter, may be collectively called “information processing terminal 102”) with communication functions, through a communication network 106. The server apparatus 104 stores a plurality of digital contents, such as moving images, and can distribute the digital contents to the information processing terminal 102. The server apparatus 104 stores content constituent elements, such as text information, and gift identification information for specifying gifts provided to part of the viewers, in association with the digital contents.

A user of the information processing terminal 102 can access the server apparatus 104 through the communication network 106 to acquire, browse, or view various digital contents, such as moving images accumulated in the server apparatus 104. The user can view the digital contents through a display, a speaker, and the like included in the information processing terminal 102. When the moving images are acquired, the moving images are replayed using application software for replaying moving images or using plug-in software for replaying moving images incorporated into a browser. In addition to the digital contents, the information processing terminal 102 acquires content constituent elements associated with the digital contents. The acquired content constituent elements can be used to create feedback information including comments for the viewed content. The information processing terminal 102 transmits the created feedback information to the server apparatus 104. When the feedback information including the content constituent elements is received, the server apparatus 104 accumulates the feedback information to allow the information processing terminals 102 other than the sender to browse the feedback information. Based on the received feedback information, the server apparatus 104 determines a winner of a gift associated with the content corresponding to the feedback information.

An operator terminal 108 is connected to and capable of communication with the server apparatus 104. The operator terminal 108 can transmit digital content to be distributed to the server apparatus 104. In place of a method of directly transmitting the digital content to the server apparatus 104, information (such as URL) for specifying the location of the storage of the digital content to be distributed may be provided to the server apparatus 104. In this case, the server apparatus 104 acquires the digital content to be distributed, from the location specified by the notified URL or the like. Additions, updates, changes, deletions, and the like are made for the digital content stored in the server apparatus 104 based on instructions from the operator terminal 108. The operator terminal 108 can notify the server apparatus 104 of one or both of the content constituent elements and the gift identification information in association with specific digital content. Although one operator terminal 108 is illustrated, a plurality of operator terminals 108 can be connected to the server apparatus 104.

A configuration of the server apparatus 104 will be schematically described with reference to FIG. 2. FIG. 2 is a block diagram schematically showing architecture of the server apparatus 104 according to an embodiment of the present invention. As shown in FIG. 2, the server apparatus 104 includes a transmitter/receiver 201, a CPU 203, a main memory 204, a user I/O 205, and an external memory 206. The elements are electrically connected to each other through an internal bus 202. The transmitter/receiver 201 is implemented as one of or a combination of hardware, firmware, and communication software for communication, such as a TCP/IP driver and a PPP driver, and the transmitter/receiver 201 can communicate with the information processing terminal 102 and the operator terminal 108 through the communication network 106. The CPU 203 loads a program, such as an operating system and an application program, from the external memory 206 to the main memory 204 and executes a command included in the loaded program. The main memory 204 is used to store a program executed by the CPU 203 and is formed by, for example, a DRAM. The user I/O 205 includes, for example, an information input apparatus, such as a keyboard and a mouse, that receives input by an operator and an information output apparatus, such as a liquid crystal display, that outputs a result of computation by the CPU 203. The external memory 206 is formed by, for example, a magnetic disk drive and includes a content accumulation unit 210, a management table 212, a feedback information accumulation unit 214, and an HTML data accumulation unit 216.

The content accumulation unit 210 accumulates digital content, such as moving images, transmitted from the operator terminal 108. The digital content is formed by, for example, converting moving images created for a TV commercial into a format, such as MPEG, suitable for network distribution. The digital content is distributed to the information processing terminal 102 in response to a request from the information processing terminal 102. The digital content can also be automatically distributed, regardless of the request from the information processing terminal 102.

The management table holding unit 212 holds a content management table 400. The content management table 400 stores various pieces of information including corresponding content constituent elements and corresponding gift identification information, in association with the digital content accumulated in the content accumulation unit 210. When the content constituent elements are notified from the operator terminal 108 in association with specific digital content, the content elements received in association with the digital content are stored. When the gift identification information is notified from the operator terminal 108 in association with specific digital content, the gift identification information received in association with the digital content is stored.

The content constituent elements include, for example, one or a plurality of pieces of text information selected by the creator of the digital content. For example, in accordance with moving images for advertising a specific product, the name of the advertised product or images evoked by the product can be selected as the content constituent elements. For example, in accordance with moving images corresponding to a TV commercial of a product called “ABC cola” which is a soft drink, three pieces of text information “ABC cola”, “refreshing”, and “pleasant” can be selected as the content constituent elements. The generated or selected content constituent elements are transmitted from the operator terminal 108 to the server apparatus 104 in association with the specific content. The content constituent elements are generated or selected in accordance with the property of the distributed content and in accordance with various objects of the person, such as a content creator, who has a right to distribute the content. There is no limitation to the data format of the content constituent elements, and other than the text information, various formats, such as image data, audio data, and video data, can be adopted. For example, image data indicating the appearance of the product advertised in the digital content or part of music or video used in the advertisement can be selected as the content constituent elements. In this way, the content constituent elements are information indicating information attached to the digital content, such as details of the digital content, and the server apparatus 104 manages the content constituent elements in association with the individual digital content.

The gift identification information is information for specifying a gift provided to the user of the information processing terminal 102 who has provided the feedback information, through a method of, for example, offering a prize. For example, the gift identification information includes a product name of the product provided as a gift and a serial number for specifying the product. Time for starting the selection of the winner is determined in advance for each gift (i.e., for each digital content associated with the gift identification information). The content constituent elements generated in this way are transmitted from the operator terminal 108 to the server apparatus 104 in association with the specific content.

The feedback information accumulation unit 214 accumulates the feedback information received from the information processing terminal 102. The feedback information is created in accordance with the information input to the information processing terminal 102, and various formats, such as a text format and HTML, can be adopted. The feedback information can be created to include the content constituent elements. When the feedback information received from the information processing terminal 102 includes the content constituent elements, the feedback information is accumulated in the feedback information accumulation unit 214 and can be browsed from the information processing terminal 102. The feedback information accumulation unit 214 does not have to store all feedback information. Part of the feedback information to be accumulated can be determined based on the data capacity or the data format, and only the part determined to be accumulated can be accumulated. The feedback information accumulation unit 214 does not have to allow the information processing terminal 102 to browse all the accumulated feedback information, but can accumulate only part of the information to allow browsing from the information processing terminal 102. The feedback information not including the content constituent elements may be accumulated in an area in the external memory 206 that cannot be accessed from the information processing terminal 102, or may be discarded without the accumulation. The feedback information accumulation unit 214 also holds a feedback information management table 500 described later.

The HTML data accumulation unit 216 accumulates HTML data downloaded to the information processing terminal 102. The HTML data is downloaded along with the digital content accumulated in the content accumulation unit 210. The browser included in the information processing terminal 102 renders the downloaded HTML data. The data obtained by rendering is output to the display and displayed on the screen. The data to be transmitted to the information processing terminal 102 can also be dynamically generated based on the HTML data accumulated in the HTML data accumulation unit 216 and based on data accumulated in other part of the external memory 206. For example, in response to an acquisition request of a page including specific moving image content, the content constituent elements associated with the moving image content requested for the acquisition and the information related to the gift (for example, product name and serial number of the product) can be read from the content management table 400. The content requested for the acquisition can be embedded in the read data to form HTML data to be provided to the information processing terminal 102. A predetermined tag, such as an <EMBED> tag and an <OBJECT> tag, can be used to embed the moving image content in the HTML data. A predetermined tag, such as a <TEXTAREA> tag and an <INPUT> tag, can be used to include the input form, such as a text box, in the HTML data. When the HTML data configured this way is received, the information processing terminal 102 uses the function of the browser to analyze the received HTML data and outputs the analyzed data to the display. As a result, the received moving images are replayed on the display, and the input form or the like for inputting information, such as the content constituent elements included in the HTML data and the information related to the gift, is displayed.

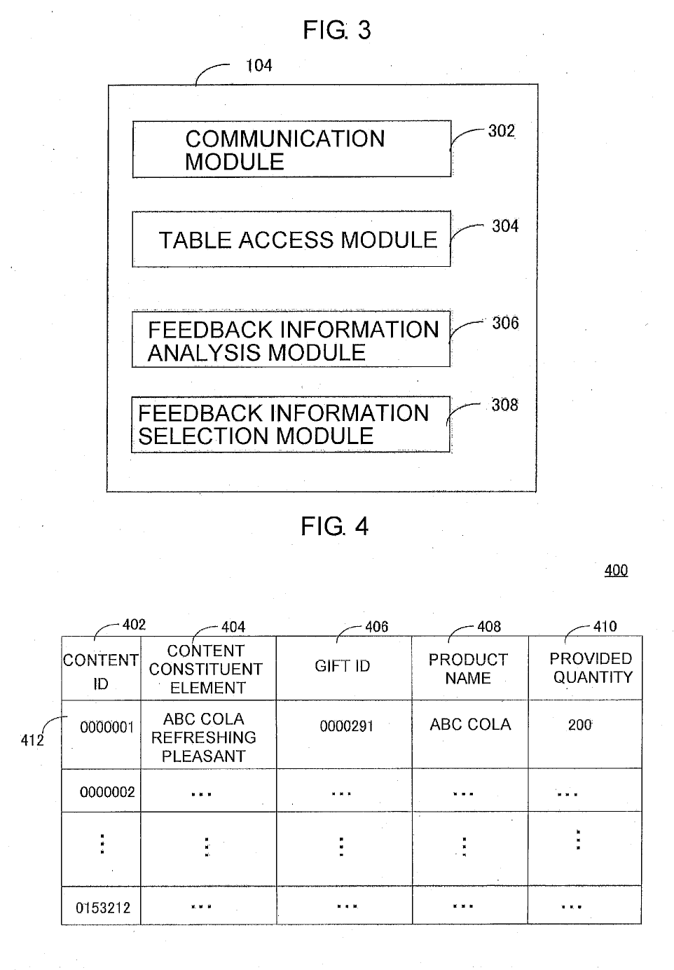

FIG. 3 is a diagram for describing functions of the server apparatus 104. The constituent elements of the server apparatus 104 shown in FIG. 2 realize the functions of the server apparatus 104 shown in FIG. 3 and the like. As shown in FIG. 3, the server apparatus 104 includes a communication module 302, a table access module 304, a feedback information analysis module 306, and a feedback information selection module 308.

The communication module 302 transfers various pieces of information between the information processing terminal 102 and the operator terminal 108. For example, the communication module 302 transmits the digital content accumulated in the content accumulation unit 210 and the HTML data accumulated in the HTML data accumulation unit 216 to the information processing terminal 102 and receives the feedback information from the information processing terminal 102. The communication module 302 also receives the digital content, the content constituent elements, and the gift identification information from the operator terminal 108. The table access module 304 stores various data provided from other modules in the content management table 400 and the feedback information management table 500 and provides data read from the tables to other modules. The feedback information analysis module 306 determines whether the received feedback information includes content constituent elements. If the received feedback information includes content constituent elements, the feedback information analysis module 306 stores the received feedback information in the feedback information accumulation unit 214 to allow browsing. The feedback information selection module 308 selects a predetermined number of messages from the feedback information accumulated in the feedback information accumulation unit 214. Predetermined gifts are provided to the users of the information processing terminals 102 that have transmitted the selected messages.

FIG. 4 is a diagram schematically showing the content management table 400. As shown in FIG. 4, the content management table 400 stores the content constituent elements associated with the digital content in association with content IDs for uniquely specifying the digital content accumulated in the content accumulation unit 210 and similarly stores the gift identification information associated with the digital content. The server apparatus 104 issues the content ID when, for example, the digital content is uploaded from the operator terminal 108 to the server apparatus 104. In this case, a new record including the issued content ID is created in the content management table 400, and the issued content ID is stored in a content ID field 402. The operator terminal 108 is notified of the issued content ID. The operator terminal 108 can use the notified content ID to specify the target record when data is added, updated, or deleted in the content management table 400.

When the content constituent elements are received from the operator terminal 108 along with the digital content, a record for storing data related to the digital content is created, and the received content constituent elements are stored in a content constituent element field 404 of the record. Instead of the digital content, the operator terminal 108 can transmit the content constituent elements in association with the notified content ID. In this case, the received content constituent elements are stored in the content constituent element field 404 of the record specified by the associated content ID.

When the gift identification information is received from the operator terminal 108 along with the digital content, the server apparatus 104 issues a gift ID for specifying the gift and stores the issued gift ID in a gift ID field 406 of the record created for the digital content.

The content management table 400 can include various other fields. For example, a field is arranged to store the name of the product corresponding to the gift ID, the serial number, the provided quantity of the gift, and the time for selecting the information processing terminal that provides the gift. For example, the content management table 400 shown in FIG. 4 includes a product name field 408 for storing data indicating the product name of the product provided as the gift and a provided quantity field 410 indicating the provided quantity of the gift. The data stored in the fields of the content management table 400 can be properly updated based on instructions from the operator terminal 108.

An example of the record held in the content management table 400 will be illustrated. FIG. 4 illustrates an example of a record 412 created for moving image content to advertise a cola drink with the product name “ABC cola”. The record 412 is created when, for example, the server apparatus 104 receives, from the operator terminal 108, the moving image content for advertising the cola drink with the product name “ABC cola” and three content constituent elements “ABC cola”, “refreshing”, and “pleasant” associated with the moving image content. A content ID “0000001” is allocated to the moving images in the server apparatus 104, and the moving images are stored in the content ID field 402 of the record 412. In the record 412, the content constituent elements “ABC cola”, “refreshing”, and “pleasant” are stored in the content constituent element field 404 in association with the content ID “0000001”. When 200 bottles of the product “ABC cola” are provided as gifts in relation to the moving images, a gift ID “0000291” for specifying “ABC cola” is stored in the gift ID field 406. The product name “ABC cola” is stored in the product name field 408, and the provided quantity “200” is stored in the quantity field 410. The product provided as the gift and the provided quantity are set or changed according to, for example, an instruction from the operator terminal 108.

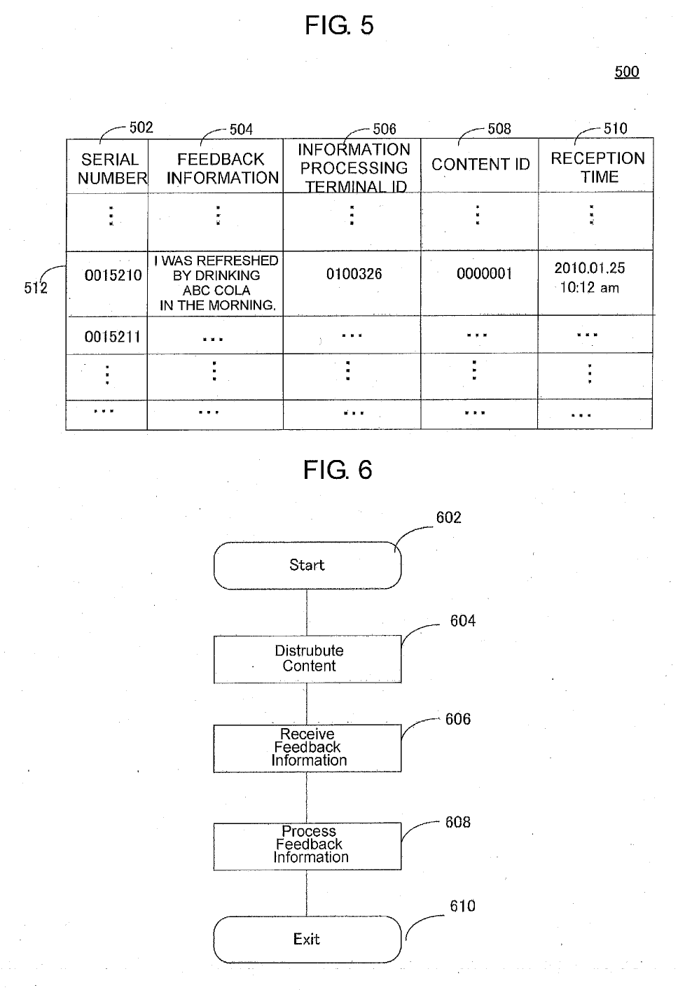

FIG. 5 is a diagram schematically showing the feedback information management table 500. The feedback information management table 500 stores, in association with received feedback information, an information processing terminal ID for specifying the information processing terminal 102 that has transmitted the feedback information, a content ID of the content related to the feedback information, and time of the reception of the feedback information. FIG. 5 shows an example of a record 512 created when feedback information “I was refreshed by drinking ABC cola in the morning.” in a text format is received from the information processing terminal 102 after the distribution of the moving images specified by the content ID “0000001” to the information processing terminal 102. The recording 512 is created in response to the reception of the feedback information. A serial number “0015210” is allocated to the received feedback information and is stored in a serial number field 502 of the record 512. The received feedback information is stored in a feedback information field 504 of the record 512. In the record 512, an information processing terminal ID “0100326” for specifying the information processing terminal 102 that has transmitted the feedback information is stored in an information processing terminal ID field 506 in association with the feedback information, and the content ID “0000001” received along with the feedback information is stored in a content ID field 508. The time of the reception of the feedback information is stored in a reception time field 510.

A processing procedure according to an embodiment of the present invention will be described with reference to FIG. 6. FIG. 6 is a flow diagram showing a processing procedure of the feedback information according to an embodiment of the present invention. Steps described in the flow diagram of FIG. 6 are executed using part or all of the elements included in the apparatus and the system. The illustrated steps that are described in detail below are only exemplary due to the nature of the steps and are not intended to be restrictive. Particularly, the steps can be executed in sequences different from the illustrated one. For example, other steps may be added to the steps shown in the flow diagram to execute the embodiments of the present invention, and two or more steps may be executed at the same time.

In step 602, a feedback information processing procedure according to an embodiment of the present invention is started. In step 604, a top page of a moving image distribution site is downloaded from the server apparatus 104 to the information processing terminal 102 in response to a request form the information processing terminal 102. The top page includes, for example, a plurality of links to pages including moving image content. The information processing terminal 102 uses a function of the browser to analyze the downloaded top page and displays the analyzed data on the screen. The links to the pages including the moving image content are displayed on the screen along with other information. Each link is, for example, paired with an image obtained by capturing part of the linked moving images and displayed. When one of the links to the pages including the moving image content displayed on the screen is selected using the function of the browser, HTML data forming the selected linked web page is downloaded from the server apparatus 104 to the information processing terminal 102. The HTML data includes the moving image content, the content ID for specifying the moving image content, the content constituent elements associated with the moving image content, the input form, such as a text box, and the information related to the gift associated with the moving image content as well as other information used to form the display screen.

For example, when the link to the moving image content specified by the content ID “0000001” is selected in the information processing terminal 102, an acquisition request of the moving image content including the content ID “0000001” is transmitted to the server apparatus 104, and the communication module 302 of the server apparatus 104 receives the acquisition request. The communication module 302 transmits the received acquisition request and the content ID “0000001” to the table access module 304. The table access module 304 acquires the content associated with the content ID “0000001” from the content accumulation unit 210 and reads the three content constituent elements “ABC cola”, “refreshing”, and “pleasant” as well as the product name “ABC cola” associated with the content ID “0000001” from the content management table 400 to integrate the data with the data read from the HTML data accumulation unit 216 to generate HTML data for distribution. The communication module 302 transmits the generated HTML data to the information processing terminal 102.

The information processing terminal 102 uses the function of the browser to analyze the downloaded HTML data and uses part of the display area of the display to replay the embedded moving images. On other parts of the display, the input form for inputting information, the product name “ABC cola”, and the content constituent elements “ABC cola”, “refreshing”, and “pleasant” are displayed along with other information. The viewer can use the input device of the information processing terminal 102 to input, to the input form, impression of the moving images and impression of the product “ABC cola” advertised in the, moving images and can transmit the feedback information including the input information to the server apparatus 104. The content constituent elements displayed on the display can be included in the information input to the input form. For example, the viewer can use part or all of the three pieces of text information “ABC cola”, “refreshing”, and “pleasant” included in the content constituent elements to create a sentence and transmit the created sentence to the server apparatus 104 as the feedback information. For example, a sentence “I was refreshed by drinking ABC cola in the morning.” is input to the input field and transmitted to the server apparatus 104. The feedback information is transmitted to the server apparatus in response to the selection of a [Send] button on the screen, along with the content ID for specifying the moving image content,

The process proceeds to step 606, and the communication module 302 receives the feedback information transmitted from the information processing terminal 102. The table access module 304 of the server apparatus 104 uses the content ID received along with the feedback information to read the content constituent elements corresponding to the content ID from the content management table 400. The feedback information analysis module 306 analyzes the received feedback information, and if the feedback information includes at least one of the content constituent elements read from the content management table 400, stores the received feedback information in the feedback information accumulation unit 214 to allow browsing. For example, when the feedback information “I was refreshed by drinking ABC cola in the morning.” is received along with the content ID “0000001”, the feedback information includes two pieces of text information “ABC cola” and “refreshing” among the three content constituent elements corresponding to the content ID “0000001” set in the content management table 400. Therefore, the feedback information “I was refreshed by drinking ABC cola in the morning.” is accumulated in the feedback information accumulation unit 214 and can be browsed. The feedback information may be able to be browsed only if the feedback information includes all content constituent elements. The implementation of a stricter acceptance standard can more surely eliminate inappropriate comments. The standard of whether to accumulate the feedback information to allow browsing can be properly changed by an instruction from the operator terminal 108. The feedback information not including the content constituent elements is stored in an area in the external memory 206 that cannot be accessed by the information processing terminal 102 or is discarded. The feedback information is stored in the feedback information management table 500 of the feedback information accumulation unit 214 in association with the content ID received together. In this way, to which content the specific feedback information stored in the feedback information accumulation unit 214 is fed back can be specified.

The information processing terminal 102 can access the server apparatus 104 to browse the feedback information stored in the feedback information accumulation unit 214. For example, the feedback information is distributed to the information processing terminal 102 along with the content associated with the feedback information. As a result, the information processing terminal 102 can display the content and the feedback information for the content on a single screen. If a plurality of pieces of feedback information are associated with specific content in the feedback information management table 500, the plurality of pieces of feedback information may be downloaded together and displayed on the screen. As a result, the user of the information processing terminal 102 can use the input form to post a comment on already registered feedback information, and interactions between users are encouraged.

The process proceeds to step 608 when the selection time of the winner for the gift associated with specific content comes. The feedback information selection module 308 selects pieces of feedback information equivalent to the provided number stored in the provided quantity field of the content management table 400 from the feedback information accumulated in the feedback information accumulation unit 214 at this point. For example, when the selection time of the winner comes regarding the content specified by the content ID “0000001”, 200 records equivalent to the provided quantity “200” are selected from the feedback information stored in association with the content ID “0000001” in the feedback information management table 500. The selection may be random, or a method of selecting records in a predetermined specific order may be adopted when the records are sorted in the order of reception. For example, the records in the order equivalent to multiples of 10 can be selected when the records are sorted in the order of reception. In this case, 10th, 20th, 30th, . . . 2000th records are selected in the order of sort. When the selection of the records is completed; a user database not shown is referenced, and the users corresponding to the information processing terminal IDs included in the selected records are specified as the winners. The gifts specified by the gift ID “0000291” are sent out to the specified users. For example, the manager of the server apparatus 104 or the operator of the operator terminal sends out the gifts.

The server apparatus 104 determines whether to allow browsing the feedback information based on whether the feedback information includes the content constituent elements. Therefore, even if feedback information not including the information processing terminal ID is received from the information processing terminal 102, the server apparatus 104 can provide the feedback information to allow browsing. In this case, the terminal that has transmitted the feedback information without the information processing terminal ID can be removed from the target of selection by the feedback information selection module 308, because the shipping address of the gift may not be specified.

As described, according to the present embodiment, the user of the information processing terminal 102 can browse only the feedback information including the content constituent elements set by the provider of the content. Therefore, browsing of inappropriate comments can be suppressed. The user who provides a comment on moving images can just post the comment by including, in the comment, the content constituent elements displayed on the screen along with the moving images to disclose the comment on the server apparatus 104. The user does not have to perform user registration or login just to post a comment.

In this way, the processing method of the present embodiment, in which the content constituent elements are used to determine whether to accept the feedback information, is different from the method, which is for permitting the comment of the user authenticated by the user ID for specifying the user, in that the user does not have to perform a registration operation in advance. Compared to the conventional method of listing up inappropriate words, the processing method of the present embodiment can simplify the setting for properly maintaining the disclosed feedback information. For example, texts and the like with meaning related to the distribution content can be adopted as the content constituent elements to allow browsing the feedback information related to the distribution content. Furthermore, if texts and the like with positive meaning for the moving image content are set as the content constituent elements to allow browsing the feedback information only when the content constituent elements are included, abusive comments can be suppressed.

The processes and the procedures described in the specification are not limited to the ones explicitly described in the embodiments. The processes and the procedures are realized by one of or an arbitrary combination of software and hardware. More specifically, the processes and the procedures described in the specification are realized by mounting logic equivalent to the processes on a medium, such as an integrated circuit, a volatile memory, a non-volatile memory, a magnetic disk, and an optical storage. The processes and the procedures described in the specification can be implemented as computer programs, and various computers can execute the computer programs.

Even if the processes and the procedures described in the specification are executed by a single apparatus, software, or component in the description, the processes and the procedures can be executed by a plurality of apparatuses, software, and components. Even if the data, tables, or databases described in the specification are stored in a single memory in the description, the data, tables, or databases may be dispersed and stored in a plurality of memories included in a single apparatus or in a plurality of memories dispersed and arranged in a plurality of apparatuses. The elements of the software and the hardware described in the specification can be integrated into fewer constituent elements or can be decomposed into more constituent elements.

A specific function executed according to an operation by the user or the operator in the specification can be automatically executed by a computer apparatus according to predetermined setting.

In this way, many changes and modifications can be made for the embodiments illustrated in the specification without departing from the scope of the present invention.

### REFERENCE SIGNS LIST

102a, 102b, 102c information processing terminals

104 server apparatus

108 operator terminal

206 external memory

302 communication module

304 table access module

306 feedback information analysis module

308 feedback information selection module

400 content management table

500 feedback information management table

1. An apparatus that can communication with a plurality of information processing terminals through a network, the apparatus comprising:
storage means for storing a plurality of digital contents, each associated with a content identifier for identifying the digital content and one or more content constituent elements;
distribution means for distributing at least one of the plurality of digital contents to at least one of the plurality of information processing terminals;
providing means for providing, to the at least one of the plurality of information processing terminals, the content constituent elements associated with the digital content distributed from the distribution means and an input form for inputting information to the at least one of the plurality of information processing terminals;
reception means for receiving, from the at least one of the plurality of information processing terminals, feedback information including information input using the input form, along with the content identifier associated with the digital content distributed from the distribution means;
determination means for determining whether the feedback information includes at least one of the content constituent elements associated with the digital content distributed from the distribution means based at least partially on the content identifier received by the reception means; and
feedback information storage means for accumulating at least part of the feedback information to allow browsing from the plurality of information processing terminals through the network if the reception means determines that the content constituent element is included.

2. The apparatus according to claim 1, wherein
at least one of the plurality of digital contents is content related to advertising, and content constituent elements associated with the content related to the advertising indicate information related to the advertising.

3. The apparatus according to claim 1 or 2, wherein
the storage means further comprises storage means for storing new digital content received through the reception means in association with a content identifier for identifying the new digital content and one or more content constituent elements.

4. The apparatus according to claim 3, wherein
the reception means receives the content constituent elements associated with the digital content, and
the storage means stores a new content constituent element received through the reception means in association with corresponding digital content.

5. The apparatus according to claim 4, wherein
the reception means receives gift identification information for specifying a gift associated with the digital content, and
the storage means stores the gift identification information in association with corresponding digital content.

6. The apparatus according to claim 5, wherein
the feedback information storage means stores the received content identifier in association with the feedback information.

7. The apparatus according to claim 6, further comprising
means for selecting a winner of the gift specified by the gift identification information accumulated in the storage means from the feedback information associated with the same content identifier as that of the gift identification information in the feedback information stored in the feedback information storage means.

8. A method executed in an apparatus that can communication with a plurality of information processing terminals through a network, the method comprising:
a step of storing a plurality of digital contents, each associated with a content identifier for identifying the digital content and one or more content constituent elements;
a step of distributing at least one of the plurality of digital contents to at least one of the plurality of information processing terminals;
a step of providing, to the at least one of the plurality of information processing terminals, the content constituent elements associated with the digital content distributed from the distribution means and an input form for inputting information to the at least one of the plurality of information processing terminals;
a step of receiving, from the at least one of the plurality of information processing terminals, feedback information including information input using the input form, along with the content identifier associated with the digital content distributed from the distribution means;
a step of determining whether the feedback information includes at least one of the content constituent elements associated with the digital content distributed from the distribution means based at least partially on the content identifier received by the reception means; and
a step of storing at least part of the feedback information to allow browsing from the plurality of information processing terminals through the network if the reception means determines that the content constituent element is included.

9. A program executed by a computer included in an apparatus that can communication with a plurality of information processing terminals through a network, the program causing the program to execute:
a procedure of storing a plurality of digital contents, each associated with a content identifier for identifying the digital content and one or more content constituent elements;
a procedure of distributing at least one of the plurality of digital contents to at least one of the plurality of information processing terminals;
a procedure of providing, to the at least one of the plurality of information processing terminals, the content constituent elements associated with the digital content distributed from the distribution means and an input form for inputting information to the at least one of the plurality of information processing terminals;
a procedure of receiving, from the at least one of the plurality of information processing terminals, feedback information including information input using the input form, along with the content identifier associated with the digital content distributed from the distribution means;
a procedure of determining whether the feedback information includes at least one of the content constituent elements associated with the digital content distributed from the distribution means based at least partially on the content identifier received by the reception means; and
a procedure of storing at least part of the feedback information to allow browsing from the plurality of information processing terminals through the network if the reception means determines that the content constituent element is included.
